(19) United States
(12) Patent Application Publication
(10) Pub. No.: US 2026/0051152 A1
(43) Pub. Date: Feb. 19, 2026

(54) Real-Time Object Recognition and Integration for Mixed-Reality Programming

(71) Applicant: DoubleMe, Inc, Seoul (KR)

(72) Inventor: Heekwan Kim, Seoul (KR)

(21) Appl. No.: 19/299,731

(22) Filed: Aug. 14, 2025

Related U.S. Application Data
(60) Provisional application No. 63/684,316, filed on Aug. 16, 2024.
(60) Provisional application No. 63/684,320, filed on Aug. 16, 2024.

(51) Int. Cl. G06V 10/764; G02B 27/01; G06T 15/00; G06V 10/82

(52) U.S. Cl. CPC G06V 10/764; G02B 27/017; G06T 15/00; G06V 10/82; G02B 2027/0138

(57) ABSTRACT

A novel real-time object recognition and integration system for mixed-reality (MR) programming and a related method of operating the system enable robust, adaptable, and seamless context-aware interactions between physical objects and digital representations in an MR environment. The novel system incorporates a multi-modal sensing module connected to a diverse set of sensors (e.g., cameras, depth sensors, IMUs) to gather rich environmental data and a real-time object detection and recognition engine that employs a uniquely-efficient neural network architecture for rapid object detection and classification. The novel system also incorporates a spatial mapping and anchoring unit to create an accurate 3D map of the environment and determine precise object positions and orientations. Furthermore, the novel system may also include a dynamic node generation module, a context analysis engine, an adaptive learning module, a visual programming interface connector, an interaction modeling system, a performance optimization module, and a safety and validation layer.

### INCORPORATION BY REFERENCE

A US provisional patent application, U.S. 63/684,320, titled “Real-Time Object Recognition and Integration for Mixed Reality Programming,” and filed on Aug. 16, 2024, is incorporated herein by reference. The present invention also claims benefit to the US provisional application of U.S. 63/684,320.

Furthermore, a US provisional patent application, U.S. 63/684,316, titled “Visual Programming System for Authoring Mixed Reality Interactions with Real and Virtual Objects,” and filed on Aug. 16, 2024, is incorporated herein by reference. The present invention also claims benefit to the US provisional application of U.S. 63/684,316.

### BACKGROUND OF THE INVENTION

The present invention generally relates to the field of mixed-reality (MR) systems and mixed-reality (MR) visualization methods. More specifically, the present invention relates to real-time object recognition and integration within MR environments. The present invention also relates to devising an advanced system for dynamically identifying real-world objects and seamlessly incorporating them into a visual programming interface for MR applications. Moreover, the present invention also relates to immersive mixed-reality visualization of real (i.e., physical) and virtual (i.e., holographic) elements in a designated real physical space.

Virtual reality (VR) and augmented reality (AR) applications are gaining increasing popularity and relevance in electronic user applications. For example, VR headsets for computers and portable devices are able to provide interactive and stereoscopic gaming experiences, training simulations, and educational environments for users wearing the VR headsets. In another example, augmented reality (AR) mobile applications are designed to add texts, descriptions, or added (i.e., “augmented”) digitized materials to physical objects if a user wears AR goggles or utilizes AR-compatible mobile applications executed in portable devices. For one of ordinary skill in the art, virtual reality (VR) refers to a completely computer-generated synthetic environment with no direct correlations to a real physical space or a real physical object, while augmented reality (AR) refers to descriptive digital materials that are displayed next to a machine-recognized real physical object to add or “augment” more information to the physical reality.

However, conventional VR and AR applications are unable to provide seamless integration of ultra-high resolution and lifelike holographic three-dimensional (i.e., “virtual”) objects juxtaposed to real physical objects located in a particular physical location for interactive and immersive curation with both synthetic and real objects, because the conventional VR applications merely provide user interactions in a purely computer-generated synthetic (i.e. virtual) environment with no correlation to physical objects in a real physical space, while the conventional AR applications merely provide additional informational overlays (i.e., information augmentation) to machine-recognized real physical objects via partially-transparent AR goggles or AR-enabled camera applications in mobile devices.

A recent evolution of conventional VR and AR applications has resulted in an innovative intermixture of computer-generated lifelike holographic virtual objects and real objects that are synchronized and correlated to a particular physical space (i.e., as a “mixed-reality” (MR) environment) for immersive user interactions during the user's visit to the particular physical space. Unfortunately, the real-time visual processing, especially in the context of mixed-reality (MR) visual programming, faces significant roadblocks in widespread commercial or consumer adaptations due to intensive image and graphical processing requirements that necessitate high-cost computing resources and specialized equipment.

Existing and conventional methods of the real-time visual processing for MR visual programming may be categorized into five approaches. The first conventional approach involves traditional computer vision techniques that utilize feature-based methods (e.g., SIFT, SURF), template matching, and contour analysis. These methods, while foundational, often struggle with real-time performance and adaptability to diverse environments. The second conventional approach involves deep learning-based object recognition, such as convolutional neural networks (CNNs), region-based CNNs (e.g., R-CNN, Fast R-CNN, Faster R-CNN), YOLO (i.e., “You Only Look Once”), and SSD (i.e., “Single Shot Detector”). Although the second conventional approach has dramatically improved the accuracy of object recognition, such a deep learning-based object recognition often requires significant and expensive computational resources, which serve as a barrier to widespread adaptations in real-time MR applications.

Furthermore, the third conventional approach involves simultaneous localization and mapping (i.e., SLAM), such as visual SLAM techniques and RGB-D SLAM systems. SLAM has been crucial for spatial understanding in MR, but typically focuses more on MR environment mapping than object recognition. In addition, the fourth conventional approach involves augmented reality (AR) standard development kits (i.e., SDKs), such as ARCore from Google, ARKit from Apple, and Vuforia. These AR SDK frameworks provide some object recognition capabilities, but are often limited to predefined targets and lack deep integration with visual programming environments. Lastly, the fifth conventional approach involves visual programming in MR, such as Unreal Engine's Blueprint system adapted for VR and Unity's visual scripting tools. While these systems offer visual programming for MR/VR, they typically lack real-time object recognition and integration capabilities.

Furthermore, the existing conventional approaches in object recognition in context of MR visual programming environments have several disadvantages and limitations that are undesirable for MR content creators, developers, and users. In particular, many existing object recognition systems introduce noticeable delays and suffer from undesirable levels of latency problems, which may disrupt the immersive experience of MR applications. Furthermore, most conventional object recognition systems have limited adaptability, as they often require pre-training on specific object sets, thus limiting their ability to recognize and integrate novel objects in real-time. In addition, conventional object recognition systems necessitate high computational intensity and processing power for high-accuracy objection recognition tasks, which often exceed the capabilities of a lower-cost spectrum of existing MR visualization devices.

Moreover, conventional object recognition systems commonly lack a seamless and machine-initiated automated integration, as there is often a disconnect between existing object recognition systems and available visual programming interfaces in mixed-reality applications, which necessitate manual human interventions to incorporate recognized objects. In addition, existing object recognition systems also suffer from context insensitivity, because such systems mostly recognize objects in isolation, without understanding their contexts or relationships within the environment. Furthermore, conventional object recognition systems have limited interaction capabilities, in which the recognized objects are often static representations that lack rich interaction possibilities within the MR environment.

There are even more disadvantages to conventional object recognition systems that should be discussed herein. For example, existing object recognition systems often struggle to maintain performance when dealing with multiple objects or complex scenes, and suffer from scalability issues. Furthermore, conventional object recognition systems also often exhibit unsatisfactory or insufficient spatial understanding, as they do not adequately account for spatial relationships and/or physical properties of the recognized objects. Existing object recognition systems also perform poorly in challenging conditions involving variable lighting, occlusions, and/or dynamic environments, often leading to a decreased accuracy in object recognition. Moreover, conventional object recognition systems typically only provide minimal or limited manipulation capabilities within a visual programming environment, once the object recognition process is completed.

Therefore, it may be beneficial to provide a more advanced and integrated approach to real-time object recognition and integration in mixed-reality (MR) programming environments. Furthermore, it may also be beneficial to provide a robust and adaptable object recognition system that seamlessly bridges the gap between physical objects and digital representations to enable rich and context-aware interactions in a visual programming interface and a corresponding framework for MR applications.

In addition, it may also be beneficial to provide a novel real-time object recognition and integration system for mixed-reality programming and a related method of operating the system that accommodate visually-intuitive integration between virtual and real elements for incorporating seamless interactions between the virtual and real elements during an MR content synthesis, instead of treating such elements separately, as in the case with existing legacy AR/VR/MR programming tools.

Moreover, it may also be beneficial to provide a novel real-time object recognition and integration system for mixed-reality programming that empowers a mixed-reality (MR) content creator to integrate robust and proactive user safety protocols, at the interaction design stage of an MR content, to prevent accidents or potentially-harmful interactions between a user immersed in the MR content and a physical object incorporated in the MR content.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In a preferred embodiment of the invention, a real-time object recognition and integration system for mixed-reality (MR) programming is disclosed. This novel system comprises: (1) a diverse set of sensors including at least one of a camera, a depth sensor, and an inertial measurement unit (IMU) sensor, wherein the diverse set of sensors is integrated into a head-mounted display device or another portable electronic device, and wherein the head-mounted display device or the another portable electronic device is configured to transmit sensory data captured from the diverse set of sensors, which are located in a physical space intended to be utilized as a mixed-reality (MR) environment, to a multi-modal sensing module; (2) the multi-modal sensing module configured to receive the sensory data captured from the diverse set of sensors, wherein the multi-modal sensing module then fuses the sensory data via a data fusion block to generate fused sensory data; (3) a real-time object detection and recognition engine utilizing a neural network to identify, classify, and track a real physical object from the fused sensory data; (4) a spatial mapping and anchoring system configured to map the physical space to generate the mixed-reality (MR) environment and to locate and correlate the real physical object and other identified real and virtual objects in the MR environment; (5) a dynamic node generation module configured to generate interactive nodes for the real physical object and the other identified real and virtual objects in a visual programming interface connected to the MR environment; (6) a visual programming interface connector configured to connect the dynamic node generation module to the visual programming interface provided by a visual programming system; (7) a safety and validation layer configured to empower a mixed-reality (MR) content creator to synthesize a user safety protocol that defines interactive limits and boundaries in mixed-reality (MR) interactions between prospective users and the real physical object to prevent user injuries or other harmful interactions when the prospective users are immersed in the MR environment; and (8) a memory unit and at least one of a central processing unit (CPU), an application processing unit (APU), and a graphical processing unit (GPU) of a computer server or another computing device executing the multi-modal sensing module, the real-time object detection and recognition engine, the spatial mapping and anchoring system, the dynamic node generation module, and the safety and validation layer, wherein the computer server or the another computing device is also operatively connected to the head-mounted display device or the another portable electronic device integrating the diverse set of sensors for data communication.

### BRIEF DESCRIPTION OF DRAWINGS

FIG. 1 shows a high-level system architecture diagram of a novel real-time object recognition and integration system for mixed-reality (MR) programming, in accordance with an embodiment of the invention.

FIG. 2 shows a multi-modal sensing process executed by the multi-modal sensing module of the novel real-time object recognition and integration system for mixed-reality programming, wherein the multi-modal sensing process combines a diverse set of sensor inputs to gather rich environmental data, in accordance with an embodiment of the invention.

FIG. 3 shows a flowchart depicting the real-time object detection and recognition process executed by the real-time object detection and recognition engine, from initial sensing to object classification, in accordance with an embodiment of the invention.

FIG. 4 shows a novel neural network architecture optimized for efficient object recognition by mixed-reality devices, in accordance with an embodiment of the invention.

FIG. 5 shows a spatial mapping and anchoring process executed by the spatial mapping and anchoring system in the novel real-time object recognition and integration system for mixed-reality programming, wherein the spatial mapping and anchoring process precisely positions the recognized objects in a three-dimensional (3D) mixed-reality environment, in accordance with an embodiment of the invention.

FIG. 6 shows a sequence diagram for the dynamic node generation process executed by the dynamic node generation module, wherein a generated node is integrated to the visual programming interface, in accordance with an embodiment of the invention.

FIG. 7 shows a user interface sequence diagram for the context analysis engine in the novel real-time object recognition and integration system for mixed-reality programming, wherein the user interface sequence diagram illustrates how spatial and temporal relationships between objects are visualized and interpreted, in accordance with an embodiment of the invention.

FIG. 8 shows a flowchart of the adaptive learning module in the novel real-time object recognition and integration system for mixed-reality programming, wherein the flowchart illustrates how the system continuously improves its recognition capabilities, in accordance with an embodiment of the invention.

FIG. 9 shows a sequence diagram for the interaction modeling system in the novel real-time object recognition and integration system for mixed-reality programming, wherein the sequence diagram demonstrates how users can define and customize interactions between recognized real objects and virtual elements, in accordance with an embodiment of the invention.

FIG. 10 shows a process flowchart for a performance optimization interface executed by the performance optimization module in the novel real-time object recognition and integration system for mixed-reality programming, wherein the process flowchart demonstrates how the system dynamically adjusts to maintain optimal performance across different devices and environments, in accordance with an embodiment of the invention.

FIG. 11 shows a use case diagram depicting various applications of the novel real-time object recognition and integration system for mixed-reality programming in diverse domains such as smart homes, industrial design, and educational environments.

FIG. 12 shows an example of a complex mixed-reality (MR) application created using the novel real-time object recognition and integration system for mixed-reality programming, wherein the example illustrates both the visual programming representation and the resulting MR experience with integrated real-world objects.

FIG. 13 shows a comparative diagram contrasting a conventional method versus an embodiment of the present invention in workflow differences for integrating real-world objects into a mixed-reality (MR) application.

FIG. 14 shows the adaptive learning capabilities of the novel real-time object recognition and integration system for mixed-reality programming, in which the recognition accuracy improves over time for different object classes.

FIG. 15 shows a user interaction diagram demonstrating how developers can manipulate and connect nodes representing recognized real-world objects within the visual programming interface provided by the novel real-time object recognition and integration system for mixed-reality programming.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble one or more electronic systems and methods for real-time object recognition and integration for mixed-reality programming. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order and do not imply any limitations in the invention.

One objective of an embodiment of the present invention is to devise a more advanced and integrated approach to real-time object recognition and integration in mixed-reality (MR) programming environments.

Another objective of an embodiment of the present invention is to devise a robust and adaptable object recognition system that seamlessly bridges the gap between physical objects and digital representations to enable rich and context-aware interactions in a visual programming interface and a corresponding framework for MR applications.

Yet another objective of an embodiment of the present invention is to devise a novel real-time object recognition and integration system for mixed-reality programming and a related method of operating the system that accommodate visually-intuitive integration between virtual and real elements for incorporating seamless interactions between the virtual and real elements during an MR content synthesis, instead of treating such elements separately, as in the case with existing legacy AR/VR/MR programming tools.

Furthermore, another objective of an embodiment of the present invention is to devise a novel real-time object recognition and integration system for mixed-reality programming that empowers a mixed-reality (MR) content creator to integrate robust and proactive user safety protocols, at the interaction design stage of an MR content, to prevent accidents or potentially-harmful interactions between a user immersed in the MR content and a physical object incorporated in the MR content.

For the purpose of describing the invention, a term referred to as “mixed reality,” or “MR,” as an acronym, is defined as an intermixture of computer-generated lifelike holographic (i.e., “virtual) objects and physical (i.e., “real”) objects that are synchronized and correlated to a particular physical space for immersive user interactions during the user's visit to the particular physical space. When experiencing a mixed-reality environment, the user is able to visualize holographic virtual objects that are computer graphics-generated and physical objects in the particular physical space simultaneously through an electronic visualization device. Typically, unlike conventional augmented reality applications, the computer-generated lifelike holographic objects are ultra high-resolution (e.g. 4K/UHD) or high-resolution (e.g. HD quality or above) three-dimensional synthetic objects that are intermixed and/or juxtaposed to real physical objects, wherein a viewer immersed in the mixed-reality environment is often unable to distinguish the synthetic nature of the computer-generated lifelike holographic objects and the real physical objects provided by the mixed-reality environment. The viewer immersed in the mixed-reality environment is typically required to be present at the particular physical space correlated and synchronized with the computer-generated lifelike holographic objects and the real physical objects in one or more mixed-reality artificial layers superimposed on the particular physical space. Furthermore, in a preferred embodiment of the invention, the viewer is also required to wear a head-mounted display (HMD) device or at least utilize a mobile electronic device configured to execute a mixed-reality mobile application, in order to experience the mixed-reality environment.

Furthermore, for the purpose of describing the invention, a term referred to as a “mixed-reality (MR) content creator” is defined as a content developer, a mixed-reality (MR) user experience designer, or a mixed-reality (MR) user interaction choreography designer, who creates, defines, and plans potential interactions and/or related choreographic interactive sequences among a mixed-reality (MR) environment user, virtual holographic object(s), and real physical object(s) that are correlated to a particular physical space. In a preferred embodiment of the invention, by utilizing robust and proactive user safety protocols integrated into the novel real-time object recognition and integration system, the MR content creator is also able to incorporate, at the outset of the interaction design stage of the MR content, some critical safety boundaries to prevent or deter potentially-dangerous interactions between an MR user and at least some real physical objects, which may pose health or physical injury risks to the MR user without proactive safety provisions at the interaction design stage.

In addition, for the purpose of describing the invention, a term referred to as a “mixed-reality artificial layer” is defined as a computer-generated graphics layer in which mixed-reality objects (MROs) and mixed-reality holographic human figures are configured to be created and positioned by the novel real-time object recognition and integration system onto virtual coordinates, which correlate to a particular physical space currently occupied by an mixed-reality (MR) user.

Moreover, for the purpose of describing the invention, a term referred to as “hologram” is defined as a three-dimensional holographic object configured to be displayed from a head-mounted display (HMD) device, a mobile device executing a mixed-reality visual mobile application, or another electronic device with a visual display unit. Typically, a hologram is capable of being animated as a three-dimensional element over a defined period of time. Examples of holograms utilized mixed-reality environments composed, synthesized, or revised by the novel real-time object recognition and integration system include, but are not limited to, a humanized holographic figure designed to interact with a mixed-reality (MR) user, or a mixed-reality virtual object, which can be intermixed with or juxtaposed to physical (i.e., real) objects for seamlessly-vivid visualizations of both artificial holograms (i.e., as virtual objects) and physical objects at a particular physical space currently occupied by the MR user.

In addition, for the purpose of describing the invention, a term referred to as “three-dimensional model,” or “3D model,” is defined as one or more computer-generated three-dimensional images, videos, or holograms. In a preferred embodiment of the invention, a computerized 3D model is created as a hologram after multi-angle video data are extracted, transformed, and reconstructed by three-dimensional graphics processing algorithms executed in a computer system or in a cloud computing resource comprising a plurality of networked and parallel-processing computer systems. The computer-generated 3D model can then be utilized as a mixed-reality object (MRO) or a humanized mixed-reality hologram (MRH) in a mixed-reality artificial layer superimposed on a particular physical space correlated by virtual coordinates from the novel real-time object recognition and integration system.

Moreover, for the purpose of describing the invention, a term referred to as “cloud” is defined as a scalable data network-connected and/or parallel-processing environment for complex graphics computations, transformations, and processing. The data network-connected and/or parallel-processing environment can be provided using a physical connection, a wireless connection, or both. For example, a cloud computing resource comprising a first cloud computing server, a second cloud computing server, and/or any additional number of cloud computing servers can each extract and transform a portion of multi-angle video data simultaneously as part of a scalable parallel processing algorithm, which performs temporal, spatial, and photometrical calibrations, and executes depth map computation, voxel grid reconstruction, and deformed mesh generation. A scalable number of cloud computing servers enables a real-time or near real-time transformation and reconstruction of 3D models after video recording devices transmit multi-angle video data to the cloud computing resource.

An important aspect of various embodiments of the present invention is in bridging the gap in real time between the real objects and the virtual objects positioned in a physical space, which enables mixed-reality (MR) content developers to interact with and manipulate representations of real-world objects within an MR programming environment. Such a fluid and seamless interactivity capability between the real objects and the virtual objects for the MR content developers in the MR programming environment is fundamental to creating more intuitive, responsive, and context-aware MR experiences.

Various embodiments of the present invention encompass several key technological areas, including but not limited to the following fields:
1. Computer Vision and Image Processing: utilizing advanced algorithms for real-time object detection, recognition, and tracking in complex, dynamic environments.
2. Machine Learning and Artificial Intelligence (AI): employing neural networks and other AI techniques for object classification, feature extraction, and continuous learning to improve recognition accuracy over time.
3. Spatial Computing: mapping and understanding the physical environment to accurately place and anchor virtual representations of real objects.
4. Real-Time Systems: ensuring low-latency processing and integration of recognized objects into the MR environment.
5. Human-Computer Interaction (HCI): designing intuitive interfaces for users to interact with recognized objects within the visual programming environment.
6. Mixed-Reality (MR) and Augmented-Reality (AR) Systems: seamlessly blending virtual and real elements in a cohesive user experience.
7. Visual Programming Languages: representing recognized real-world objects as manipulable nodes within a visual programming interface.

Furthermore, various embodiments of the present invention are configured to operate in conjunction with various mixed-reality (MR) hardware, including but not limited to: (1) a head-mounted display (HMD) with integrated camera(s); (2) a smartphone with integrated camera(s) and display panel(s); (3) MR-compatible smart glasses with environmental-sensing capabilities; and (4) a standalone AR/MR device with advanced sensor arrays.

Moreover, it should be noted herein that the applications of various embodiments of the present invention can impact a wide range of industries and use cases, including but not limited to the following fields:
1. Education and Training: creating interactive, object-based learning experiences.
2. Industrial Design and Prototyping: rapidly integrating physical prototypes into digital design workflows.
3. Smart Home and IoT Integration: recognizing and programming interactions with smart devices in real-time.
4. Retail and E-commerce: enabling virtual try-on and product visualization experiences.
5. Healthcare and Medical Imaging: recognizing medical equipment and anatomy for training and assisted procedures.
6. Architecture and Construction: integrating building elements and materials into digital plans and simulations.
7. Entertainment and Gaming: creating dynamic, environment-aware mixed reality games and experiences.
8. Accessibility Applications: assisting visually impaired users by recognizing and describing objects in their environment.

By providing a robust system for real-time object recognition and integration, various embodiments of the present invention aims to significantly enhance the capabilities of mixed-reality (MR) programming environments. Embodiments of the present invention enable MR content developers and end-users to create more responsive, context-aware, and immersive mixed-reality applications that can dynamically adapt to and interact with the physical world around them. Furthermore, various innovations incorporated in one or more embodiments of the present invention represent a crucial step forward in making mixed-reality systems more intuitive, powerful, and deeply integrated with the developers'and/or the end users'physical surroundings, thus opening up new possibilities for interacting with and controlling the digital content in relation to the real-world objects and the physical space containing them.

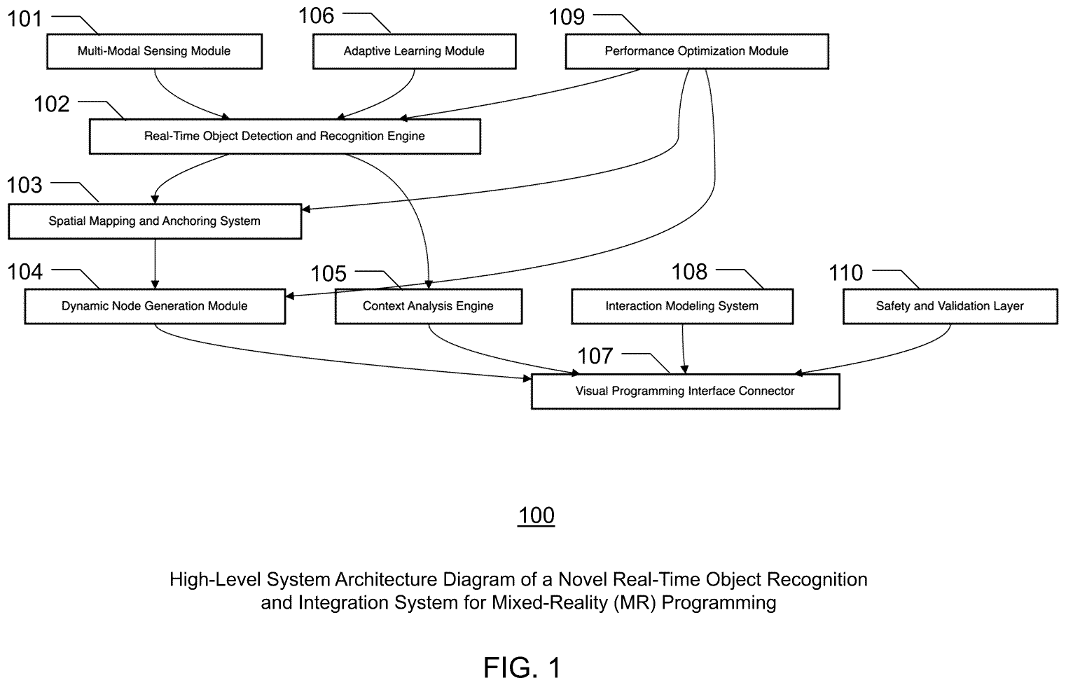

FIG. 1 shows a high-level system architecture diagram (100) of a novel real-time object recognition and integration system for mixed-reality (MR) programming, in accordance with an embodiment of the invention. As illustrated in the high-level system architecture diagram (100), the novel real-time object recognition and integration system for MR programming comprises: (1) a multi-modal sensing module (101), which is operatively connected to various sensors (e.g., cameras, depth sensors, inertial measurement unit (IMU) sensors) to gather a diverse and rich set of environmental data; (2) a real-time object detection and recognition engine (102), which employs a novel and efficient neural network architecture for rapid object detection and classification; and (3) a spatial mapping and anchoring system (103), which creates an accurate three-dimensional (3D) map of the environment and determines precise object positions and orientations.

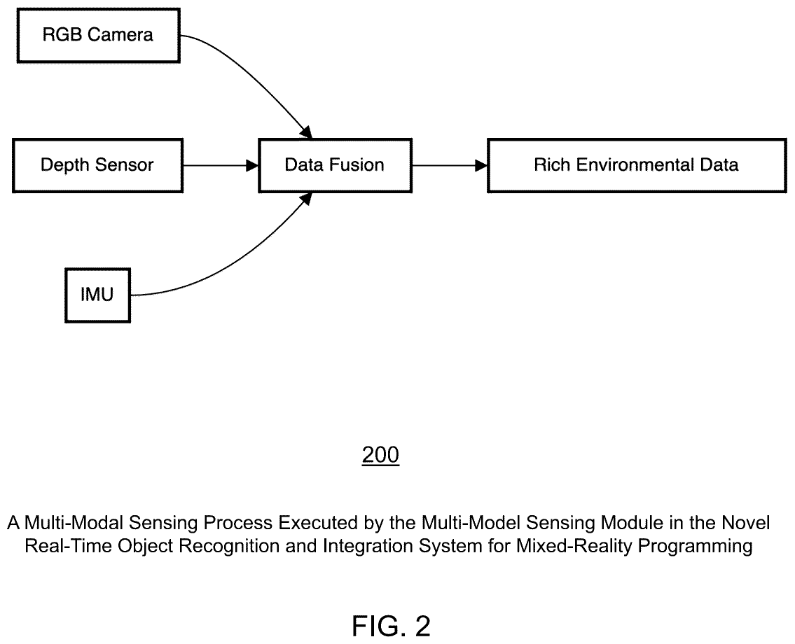

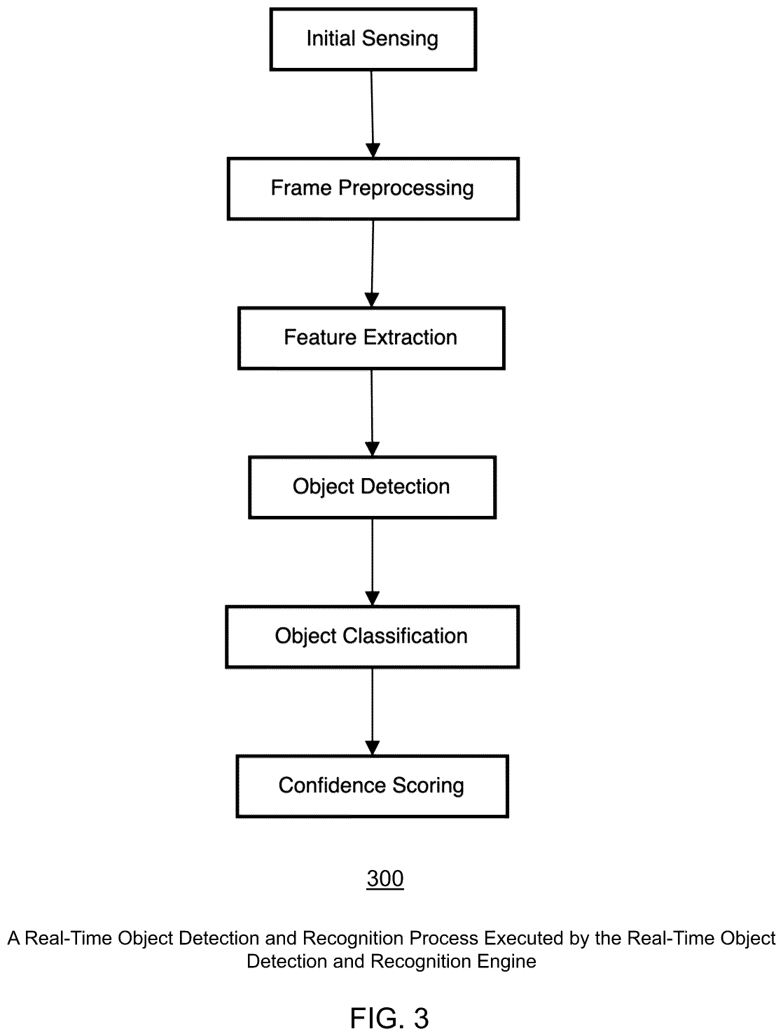

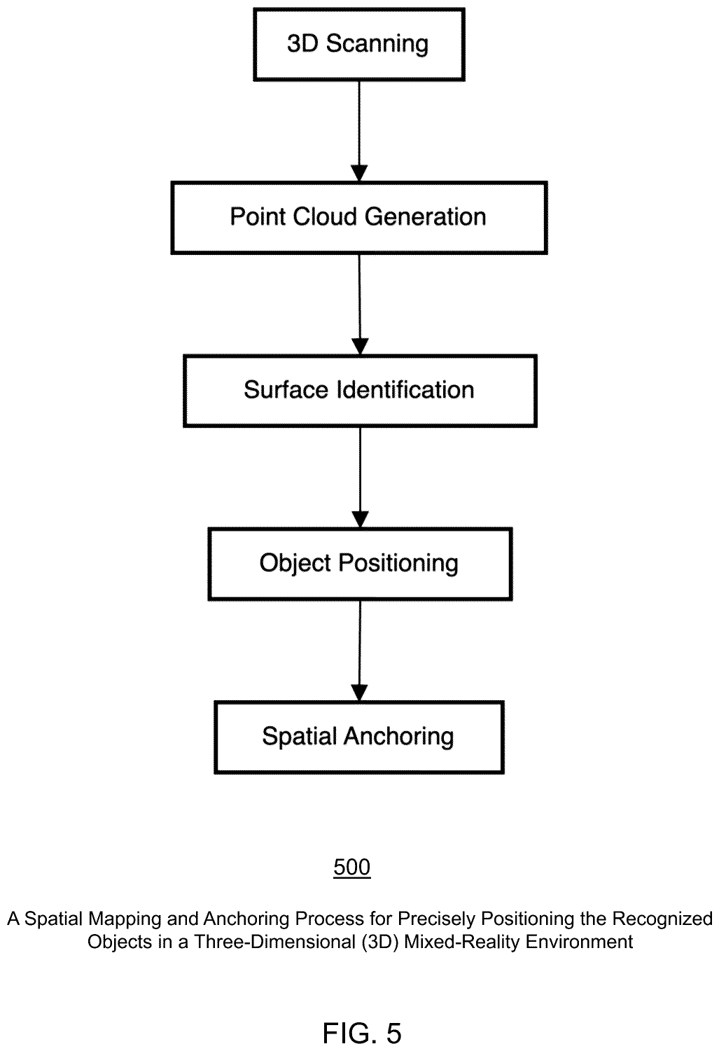

The multi-modal sensing module (101), as shown in the high-level architecture diagram (100) in FIG. 1, is further elaborated in conjunction with FIG. 2, and the real-time object detection and recognition engine (102) is further elaborated in conjunction with FIG. 3. Moreover, the spatial mapping and anchoring system (103) is further elaborated in conjunction with FIG. 5. Although these three components provide core functionalities to the novel real-time object recognition and integration system for MR programming, there are several other modules in the preferred embodiment of the invention that provide additional improvements, fine-tuning, and complete functionalities to the novel real-time object recognition and integration system for MR programming.

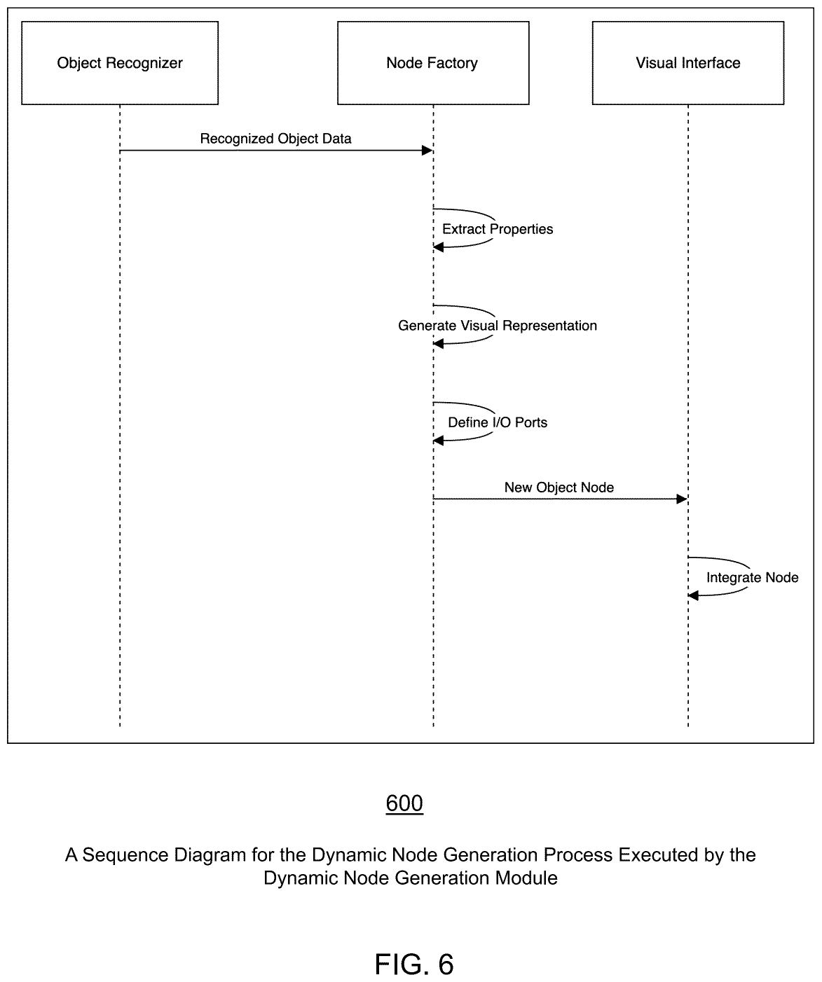

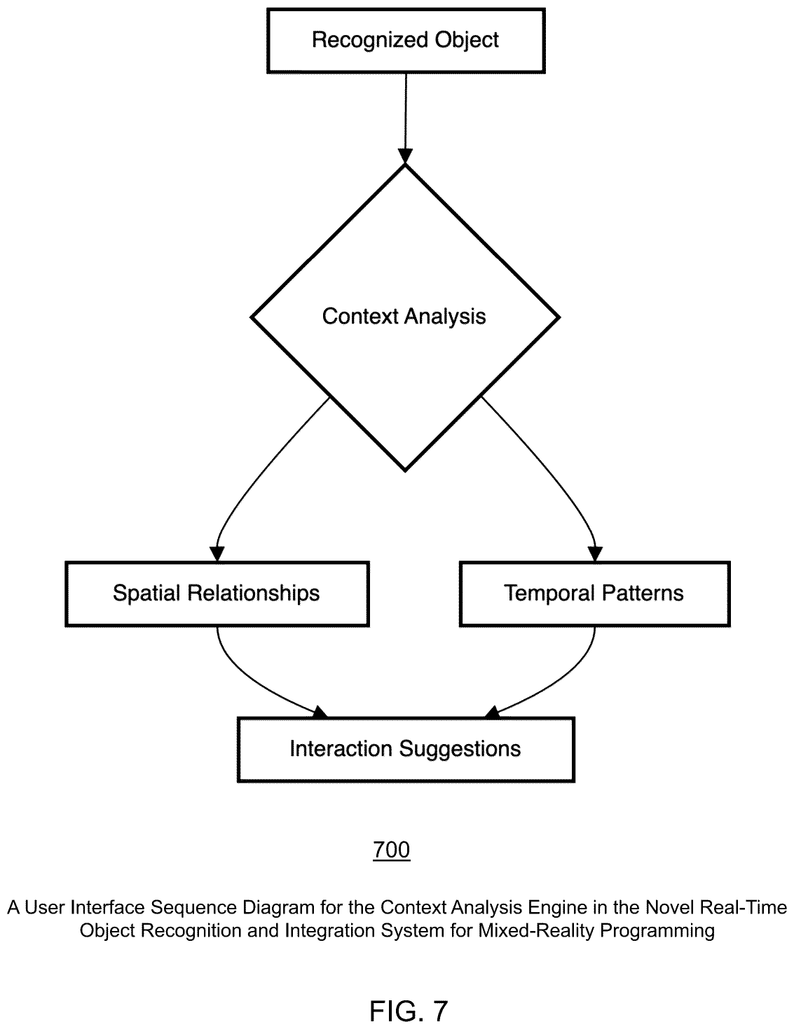

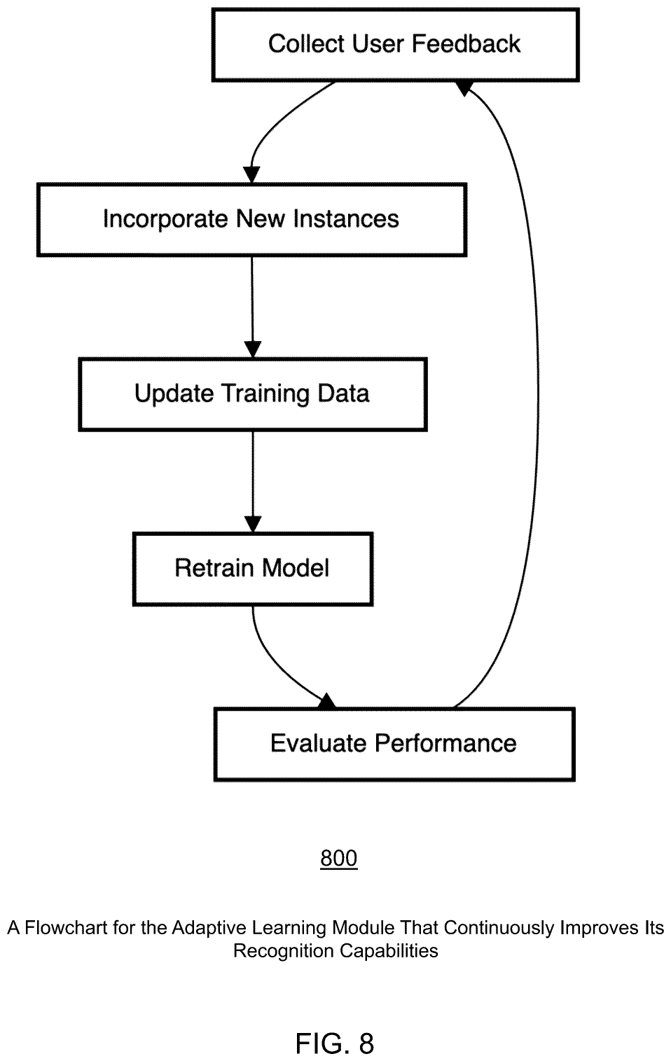

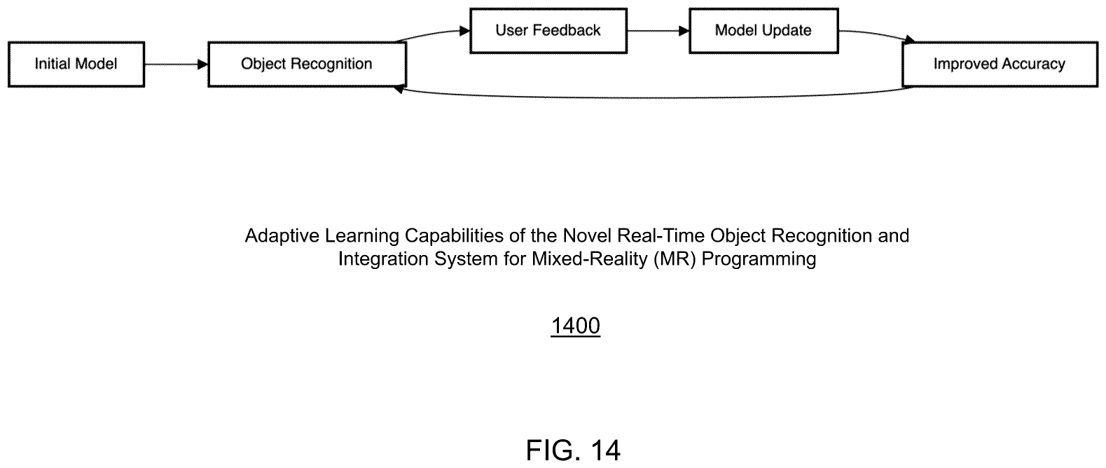

In particular, in the preferred embodiment of the invention, the novel real-time object recognition and integration system for MR programming, in addition to the three core components, also comprises: (4) a dynamic node generation module (104), which automatically creates representative nodes in the visual programming interface for recognized objects; (5) a context analysis engine (105), which interprets spatial and temporal relationships between objects to infer context and potential interactions; (6) an adaptive learning module (106), which continuously refines the recognition model executed by the real-time object detection and recognition engine (102) based on new observations and user feedback; and (7) a visual programming interface connector (107), which seamlessly integrates recognized objects into the existing visual programming framework. The dynamic node generation module (104), as shown in the high-level architecture diagram (100) in FIG. 1, is further elaborated in conjunction with FIG. 6, and the context analysis engine (105) is further elaborated in conjunction with FIG. 7. Furthermore, the adaptive learning module (106) is further elaborated in conjunction with FIG. 8 and FIG. 14.

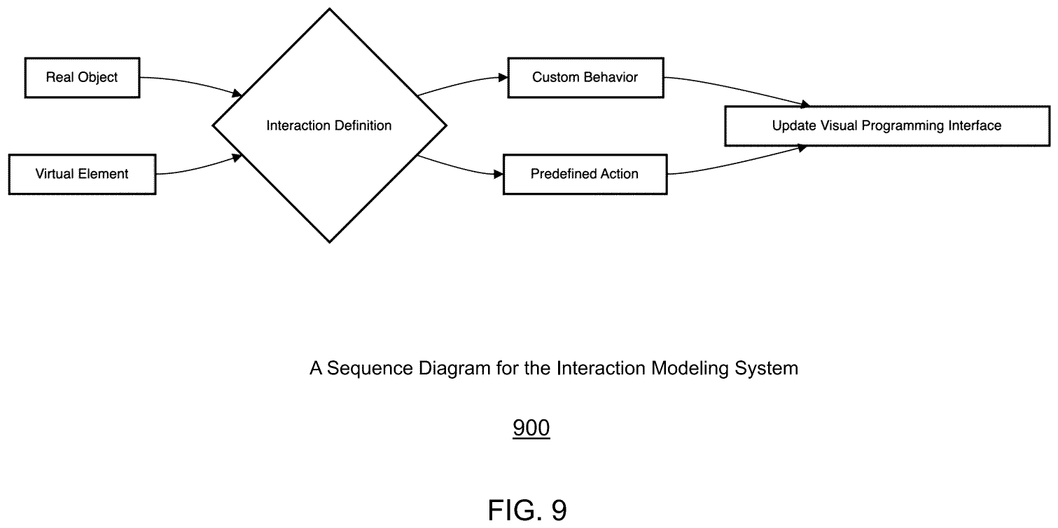

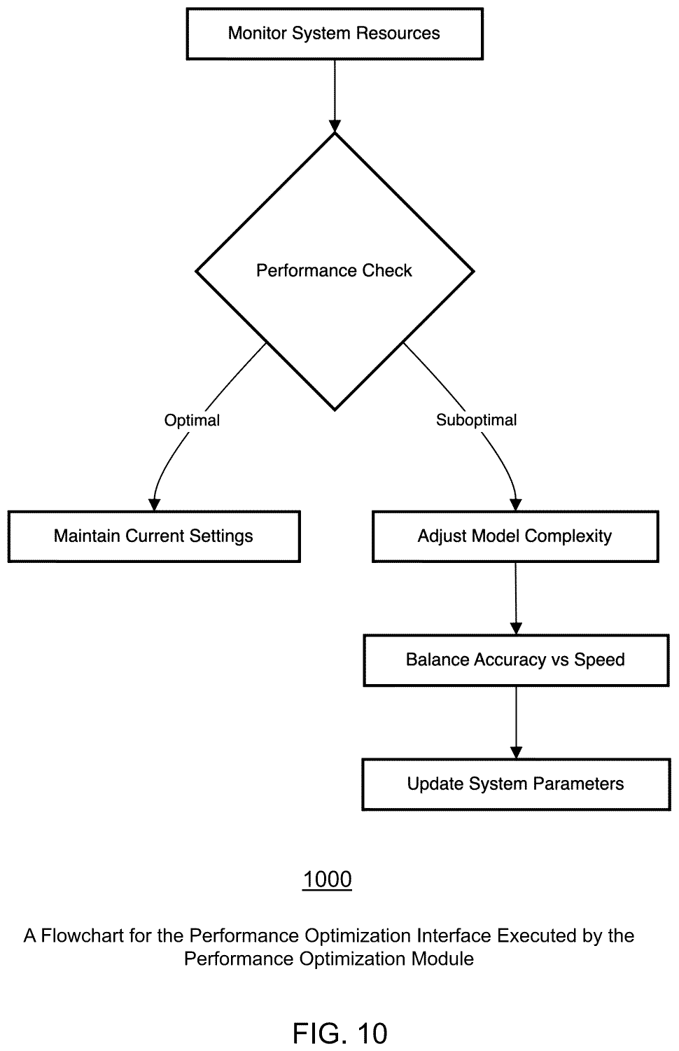

Moreover, in the preferred embodiment of the invention, the novel real-time object recognition and integration system for MR programming also comprises the following additional elements that further improve the functionality of the system: (8) an interaction modeling system (108), which defines and manages possible interactions between recognized real objects and virtual elements; (9) a performance optimization module (109), which dynamically adjusts system parameters to maintain optimal performance across various devices and environments; and (10) a safety and validation layer (110), which ensures that interactions with recognized real-world objects adhere to safety protocols designed and defined by an MR content developer. The interaction modeling system (108), as shown in the high-level architecture diagram (100) in FIG. 1, is further elaborated in conjunction with FIG. 9, and the performance optimization module (109) is further elaborated in conjunction with FIG. 10.

In the preferred embodiment of the invention as shown in FIG. 1, the novel real-time object recognition and integration system for MR programming operates by continuously scanning the environment through various sensors (e.g., cameras, depth sensors, inertial measurement unit (IMU) sensors) integrated in one or more MR devices connected to the multi-modal sensing module (101). As objects are detected and recognized by the real-time object detection and recognition engine (102), they are immediately mapped into the 3D space by the spatial mapping and anchoring system (103) and then represented as interactive nodes within the visual programming interface by the dynamic node generation module (104), which is connected to the visual programming interface via the visual programming interface connector (107). The mixed-reality (MR) content creators can then incorporate these nodes into their MR content development and/or applications, and define the behaviors and the interactions among the interactive nodes via the interactive modeling system (108), which is also operatively connected to the visual programming interface via the visual programming interface connector (107), to ensure that both virtual and real objects are seamlessly blended during the MR content synthesis and development.

For example, a camera in an MR device may scan a physical Internet-of-Things (IoT) device, which is detected and recognized by the real-time object detection and recognition engine (102). The physical IoT device is then mapped into the 3D space by the spatial mapping and anchoring system (103) and represented as an interactive node (e.g., “a physical IoT device node”) within the visual programming interface by the dynamic node generation module (104). An MR content creator, while accessing the novel real-time object recognition and integration system for MR programming, can then visually program (i.e., as part of an MR content creation) interactions between this node and virtual elements, such as displaying data visualizations around the physical IoT device node, or triggering virtual effects based on the current state of the physical IoT device in the MR environment.

In the preferred embodiment of the invention, one or more of the multi-modal sensing module (101), the real-time object detection and recognition engine (102), the spatial mapping and anchoring system (103), the dynamic node generation module (104), the context analysis engine (105), the adaptive learning module (106), the visual programming interface connector (107), the interaction modeling system (108), the performance optimization module (109), and the safety and validation layer (110) of the novel real-time object recognition and integration system for MR programming are software components that are executed in a central processing unit (CPU), an application processing unit (APU), a graphical processing unit (GPU), and/or a memory unit of a computer server or another computing device. The computer server or another computing device that executes these software components are also operatively connected to the mixed-reality (MR) hardware devices (e.g., a head-mounted display (HMD) device incorporating a camera, position sensors, and accelerometers, or a smartphone integrating a camera and one or more sensors, etc.) for data communication of scanned, captured, recorded, and/or displayed information associated with real physical objects, virtual holographic objects, and a physical environment used to generate a mixed-reality (MR) content and an associated MR environment.

By providing a real-time, adaptive, and deeply-integrated object recognition system for mixed-reality (MR) programming, various embodiments of the present invention significantly enhance the capabilities of mixed-reality (MR) content creation and development environments. In particular, the novel real-time object recognition and integration system for MR programming enables the MR content creators to be visually immersed in a 3D environment during content development, with both real and virtual objects readily recognized and represented as interactive nodes in the visual perspective of each MR content creator, wherein each interactive node is designed to be controlled, choreographed, and/or directed by the MR content creators for synthesizing seamless MR interactivity experiences across various real and virtual objects in the MR environment. The novel real-time object recognition and integration system for MR programming empowers content developers to create more responsive, context-aware, and immersive MR applications that can dynamically adapt to and interact with the physical world around them.

FIG. 2 shows a multi-modal sensing process (200) executed by the multi-modal sensing module (i.e., 101 in FIG. 1) of the novel real-time object recognition and integration system for mixed-reality programming, wherein the multi-modal sensing process combines a diverse set of sensor inputs to gather rich environmental data, in accordance with an embodiment of the invention. In the multi-modal sensing process (200) as illustrated in FIG. 2, a red-green-blue (RGB) camera, a depth (i.e., perspective or z-axis) sensor, and an inertial measurement unit (IMU) sensor provide the diverse set of sensory inputs, which are fused by a data fusion block and packaged as “rich environmental data,” or “fused sensory data” by the multi-modal sensing module (i.e., 101 in FIG. 1), in a preferred embodiment of the invention.

Typically, the RGB camera is configured to provide color image data for visual recognition, while the depth sensor supplies an additional depth and perspective (i.e., z-axis) 3D spatial information that can enhance object segmentation and positioning. Furthermore, the IMU sensor can provide device orientation and movement data, which assists in environment tracking of the real and/or virtual objects in an MR environment. As shown in the multi-modal sensing process (200) in FIG. 2, in the preferred embodiment of the invention, the multi-modal sensing module (i.e., 101 in FIG. 1) employs sensor fusion techniques to combine these diverse data streams, creating a rich and multi-dimensional representation of the physical space intended to be utilized as the MR environment. In another embodiment of the invention, other or additional sensors may provide extra sensory inputs to the multi-modal sensing module, depending on the needs of a particular MR programming development platform utilized by content creators.

In the preferred embodiment of the invention, the fused sensory data (i.e., rich environmental data) is then transmitted to the real-time object detection and recognition engine (i.e., 102 in FIG. 1) for additional processing (e.g., frame preprocessing, feature extraction, etc.), object detection, and object classification. Furthermore, in some cases, the multi-modal sensing module (i.e., 101 in FIG. 1) and the real-time object detection and recognition engine (i.e., 102 in FIG. 1) may be combined as an integrated multi-component module, called the “object recognition module”. Whether these two components remain physically separate or at least partially combined to constitute a singular module, the multi-modal sensing module and the real-time object detection and recognition engine serve as the core of the system's ability to identify and classify real-world objects in real time.

FIG. 3 shows a flowchart (300) depicting the real-time object detection and recognition process executed by the real-time object detection and recognition engine (i.e., 102 in FIG. 1), from initial sensing to object classification, in accordance with an embodiment of the invention. As illustrated in the flowchart (300), the real-time object detection and recognition process can be outlined in six steps, in the preferred embodiment of the invention. The first step is “initial sensing,” which involves capturing, recording, packaging, and transmitting sensory data from various sensors connected to the multi-modal sensing module (i.e., 101 in FIGS. 1, 200 in FIG. 2) to the real-time object detection and recognition engine (i.e., 102 in FIG. 2).

The real-time object detection and recognition engine then executes a “frame preprocessing” step to transform raw video frames or other sensor data into a suitable format for effective analysis. In the preferred embodiment of the invention, the frame preprocessing step may execute frame selection, resizing, normalization, augmentation, sequence formation, and/or sequence encoding to ensure that the preprocessed frames are converted into a suitable format for additional analysis by the real-time object detection and recognition engine. Then, the output of the frame preprocessing step is further analyzed by the real-time object detection and recognition engine in a “feature extraction” step, which identifies and quantifies salient characteristics, or “features,” within an image to represent it numerically.

The feature extraction step is an important processing step to provide dimensionality reduction that enables the real-time object detection and recognition process to focus on the most relevant information while making the image processing more efficient. Furthermore, by providing the real-time object detection and recognition engine with meaning features instead of raw pixels, the feature extraction step can lead to better detection and recognition accuracy and faster processing times. The quantified and extracted features also capture important visual aspects like edges, corners, textures, and shapes, which allow the real-time object detection and recognition engine to prepare for an enhanced contextual understanding of the image content.

Continuing with the flowchart (300) depicting the real-time object detection and recognition process in FIG. 3, the real-time object detection and recognition engine (i.e., 102 in FIG. 1) then executes an “object detection” step, which involves object localization that attempts to identify and locate objects within an image or video frame and drawing bounding boxes around them. The object localization determines the precise location of objects within an image, and draws a bounding box around each identified object to indicate its spatial context. Then, an “object classification” step is executed by the real-time object detection and recognition engine, which involves assigning a specific category or class label to each detected object. For example, once an object is localized, the localized object is classified into a specific category (e.g., furniture, household items, humans, animals, etc.). This involves recognizing the features and patterns that distinguish different object types.

Then, as shown as a last step in the flowchart (300) depicting the real-time object detection and recognition process in FIG. 3, a confidence scoring task is performed on the classified objects. In the preferred embodiment of the invention, a confidence score reflects how certain a detected object is correctly identified and located. The confidence scoring task is based on a probability model, typically ranging from 0 to 1 (i.e., 0% to 100%), indicating the likelihood of a correct detection. A higher score signifies greater confidence in the prediction. For instance, a confidence score represents the probability that the bounding box contains the object and that the object belongs to the predicted class. Object detection models can generate confidence scores for each detected object. A confidence threshold may also be utilized to filter out false positives, and in such instances, only the detected objects with scores above this threshold are considered valid.

In the preferred embodiment of the invention, the real-time object detection and recognition engine (i.e., 102 in FIG. 1) may utilize object detection models based on deep-learning architectures like Convolutional Neural Networks (CNNs), which are configured to train themselves continuously to recognize visual patterns and features associated with different object classes. The CNNs are trained on large datasets containing images with annotated objects and their corresponding bounding box coordinates and class labels. During inference, the model processes new images, identifies potential object regions, and then classifies them based on the learned features. The CNNs typically incorporate convolutional layers, which are configured to process data with grid-like topology, such as images and videos. Typically, the convolutional layers apply a convolution operation using learnable filters, or kernels, to extract features from the input data. This process helps the network identify patterns and features within the input, enabling tasks like image recognition and object detection.

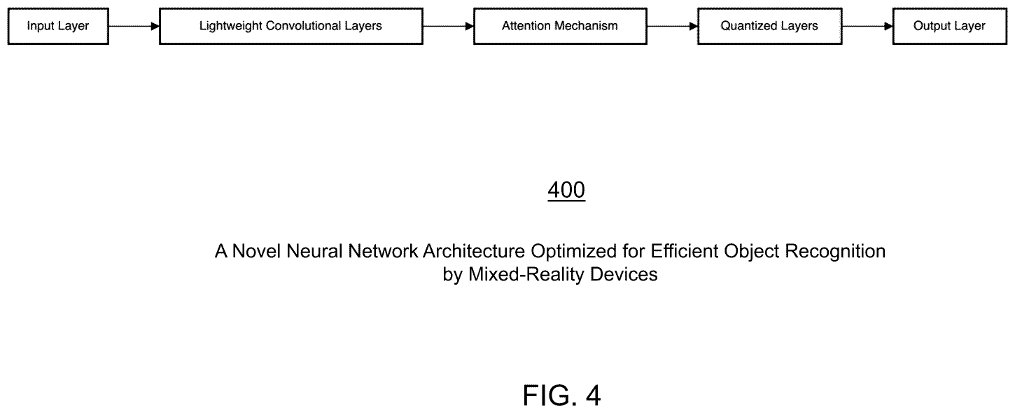

FIG. 4 shows a novel neural network architecture (400) optimized for efficient object recognition by mixed-reality devices, in accordance with an embodiment of the invention. In particular, the real-time object detection and recognition engine (i.e., 102 in FIG. 1) may utilize this novel neural network architecture (400), which incorporates several advantageous key features: (1) lightweight convolutional layers, which are designed for efficient processing on mobile GPUs; (2) attention mechanisms, which focus computational resources on the most relevant parts of the input; (3) quantization layers, which reduce model size and inference time while maintaining accuracy; and (4) model pruning, which removes redundant parameters to further optimize performance.

As illustrated in FIG. 4, the novel neural network architecture (400) also contains an input layer that receives multimedia data for neural network processing by the lightweight convolution layers, the attention mechanism, and the quantized layers. Furthermore, the novel neural network architecture (400) also contains an output layer that transmits the processed multimedia data to other components (e.g., 103, 105 in FIG. 1) of the system from the real-time object detection and recognition engine (i.e., 102 in FIG. 1).

FIG. 5 shows a spatial mapping and anchoring process (500) executed by the spatial mapping and anchoring system (i.e., 103 in FIG. 1) in the novel real-time object recognition and integration system for mixed-reality programming, wherein the spatial mapping and anchoring process precisely positions the recognized objects in a three-dimensional (3D) mixed-reality environment, in accordance with an embodiment of the invention. The spatial mapping and anchoring process (500) scans a targeted physical space and creates a detailed 3D map of the targeted physical space intended to be utilized as a mixed-reality (MR) environment.

In the preferred embodiment of the invention, the spatial mapping and anchoring process (500) incorporates SLAM (Simultaneous Localization and Mapping) techniques to achieve one or more of the following tasks, as illustrated in FIG. 5: (1) generating a point cloud representation of the physical space intended to be used as the MR environment; (2) identifying planar surfaces and geometric shapes via a surface identification process; (3) tracking the MR device's position relative to the MR environment; (4) precisely locating and anchoring recognized real (i.e., physical) objects within the MR environment via an object positioning process and a spatial anchoring process.

Importantly, the spatial mapping and anchoring process (500) allows programming elements to be tied to specific locations in the physical environment. The spatial mapping and anchoring process (500) provides a seamless and unifying position coordinates between real objects and virtual objects by utilizing a spatial anchor that enables virtual objects originally defined in native programming system (i.e., local) coordinates to be fully translated to a world coordinate system, which defines the positions of the real objects relative to an actual physical space intended to provide a mixed-reality (MR) visualization environment.

Therefore, the spatial mapping and anchoring system (i.e., 103 in FIG. 1) recognizes real physical objects in the actual physical space via computer vision from earlier processing steps with other modules (i.e., 101 and 102 in FIG. 1), and the current position of each recognized real object is categorized and entered into the world coordinate system, while also being linked to the spatial anchor for real-time tracking of the future position of each recognized real object. Furthermore, the spatial mapping and anchoring system (i.e., 103 in FIG. 1) of the novel real-time object recognition and integration system for mixed-reality programming executes simultaneous localization and mapping (SLAM) algorithms and techniques to generate a digital map of the structure of the actual physical space intended for the MR visualization environment, as also illustrated in FIG. 5. This digital map of the structure and related position coordinates, preferably standardized to the world coordinate system, are then entered into the spatial anchor for real-time position tracking of virtual and real objects in context of the physical space intended for the MR visualization environment.

Moreover, the virtual holographic objects created by an MR content creator are initially defined in the native programming system (i.e., local) coordinates, which are subsequently translated into and transformed to the world coordinate system that defines the positions of real objects and the structure of the physical space intended for the MR visualization environment. In addition, each virtual object is dynamically linked, or “anchored”, to the spatial anchor, which keeps track of current and future position changes of virtual objects and real objects within the physical space, in real time. Typically, the real-time position tracking of various objects and elements by the spatial anchor is executed in a singular and unified coordinate system, such as the world coordinate system. In the preferred embodiment of the invention, the spatial anchor has a defined anchor point within the physical space intended for the MR visualization environment. Importantly, the spatial anchor, provided by the spatial mapping and anchoring system (i.e., 103 in FIG. 1) within the novel real-time object recognition and integration system for mixed-reality programming, serves as a unified and coherent real-time position-tracking platform for various real physical objects, holographic virtual objects, and physical structures in the MR visualization environment.

FIG. 6 shows a sequence diagram (600) for the dynamic node generation process executed by the dynamic node generation module, wherein a generated node is integrated to the visual programming interface, in accordance with an embodiment of the invention. Once an object is recognized and spatially anchored, from the previous tasks performed by other modules (i.e., 101, 102, and 103 in FIG. 1) of the novel real-time object recognition and integration system for mixed-reality programming, the dynamic node generation module (i.e., 104 in FIG. 1) creates a corresponding node in the visual programming interface provided by the novel real-time object recognition and integration system for mixed-reality programming.

As illustrated by the sequence diagram (600) in FIG. 6, this process involves one or more of the following steps: (1) extracting relevant object properties (e.g., size, color, functionality); (2) generating a visual representation of the object as a node; (3) defining input/output ports based on the object's potential interactions; and (4) integrating the node into the existing node graph. In the preferred embodiment of the invention, the dynamic node generation module (i.e., 104 in FIG. 1) is configured to create representative nodes automatically in the visual programming interface for each recognized objects.

Furthermore, in the preferred embodiment of the invention, connections between nodes can be represented by lines to indicate the flow of data or events in the visual programming interface, while an MR content creator is immersed in the development and programming environment. The node-based connections in the visual programming interface enable the MR content creator to draw lines between nodes to establish relationships and define interactions between elements and/or objects. Mixed-reality experience designers (i.e., content creators, application developers, etc.) can create these connections by drawing lines between node ports using mixed-reality controllers or gesture-based inputs while being immersed in a three-dimensional visual programming interface provided by the novel real-time object recognition and integration system for mixed-reality programming.

Moreover, as illustrated in the sequence diagram (600) in FIG. 6 for the dynamic node generation process, the step of integrating the node into the existing node graph requires communication with the visual programming interface connector (i.e., 107 in FIG. 1), which seamlessly integrates recognized objects as new nodes into the existing visual programming framework. The graphical representation of the newly-recognized objects as new interactive nodes within the visual programming interface is made possible by the multimedia data communication mediated by the visual programming interface connector (i.e., 107 in FIG. 1) between the dynamic node generation module (i.e., 104 in FIG. 1) and the visual programming interface. The mixed-reality (MR) content creators can then incorporate these nodes into their MR content development and/or applications, and define the behaviors and the interactions among the interactive nodes via the interactive modeling system (i.e., 108 in FIG. 1), which is also operatively connected to the visual programming interface via the visual programming interface connector (i.e., 107 in FIG. 1), to ensure that both virtual and real objects are seamlessly blended during the MR content synthesis and development.

FIG. 7 shows a user interface sequence diagram (700) for the context analysis engine (i.e., 105 in FIG. 1) in the novel real-time object recognition and integration system for mixed-reality programming, wherein the user interface sequence diagram (700) illustrates how spatial and temporal relationships between objects are visualized and interpreted, in accordance with an embodiment of the invention. The context analysis engine (i.e., 105 in FIG. 1) is able to enhance MR content creators'programming and content development experiences by providing intelligent suggestions for object interactions.

For example, as illustrated in the user interface sequence diagram (700) in FIG. 7, the context analysis engine is configured to perform one or more of the following tasks, in the preferred embodiment of the invention: (1) analyzing spatial relationships between objects via context analysis and spatial relationship analysis; (2) detecting and/or determining temporal patterns in object states or movements via temporal pattern analysis; and (3) generating machine-initiated, autonomous, and intelligent suggestions for potential interactions, connections, or behaviors based on recognized contexts to the MR content creators. In general, the context analysis engine is configured to provide machine-initiated interpretations of spatial and temporal relationships between the recognized objects to infer contexts and potential interactions. Furthermore, the context analysis engine may be fully autonomous and thus typically does not require any human intervention to generate intelligent suggestions to the MR content creators in the visual programming interface.

FIG. 8 shows a flowchart (800) of the adaptive learning module (i.e., 106 in FIG. 1) in the novel real-time object recognition and integration system for mixed-reality programming, wherein the flowchart (800) illustrates how the system continuously improves its recognition capabilities, in accordance with an embodiment of the invention. The novel real-time object recognition and integration system incorporates adaptive learning and dynamic optimization to ensure ongoing improvement and optimal performance, based on trends and/or ongoing changes in historical and real-time information.

In the preferred embodiment of the invention, the adaptive learning module (i.e., 106 in FIG. 1) is able to provide a continuous refinement on an object recognition model by collecting user feedback on recognition accuracy, incorporating new object instances into the training data for object recognition, and periodically retraining the model to improve accuracy and expand its recognition capabilities, as shown in the flowchart (800) in FIG. 8. The adaptive learning module also continuously evaluates performance parameters by checking the current state of object recognition accuracy after the object recognition model is updated and retrained.

FIG. 9 shows a sequence diagram (900) for the interaction modeling system (i.e., 108 in FIG. 1) in the novel real-time object recognition and integration system for mixed-reality programming, wherein the sequence diagram (900) demonstrates how users can define and customize interactions between recognized real objects and virtual elements, in accordance with an embodiment of the invention. As illustrated in FIG. 9, the interaction modeling system takes recognized real objects and existing virtual elements in the mixed-reality programming environment as input values to an interaction definition unit. Typically, the input values are represented by interactive nodes that correspond to the real objects and the existing virtual elements, as processed previously (e.g., 102, 103, and 104 in FIG. 1) by the novel real-time object recognition and integration system for mixed-reality programming.

As shown in the sequence diagram (900) in FIG. 9, the interaction definition unit in the interaction modeling system (i.e., 108 in FIG. 1) is configured to assign and/or define custom behaviors or specific actions (i.e., predefined actions) per each interactive node, based on the inherent characteristics of each interactive node and customized definitions and interactive directions given by an MR content creator. Then, based on the updated interaction definition assigned to each interactive node, the interaction modeling system also updates the visual programming interface for the MR content creator, who is able to visualize the updated interaction definitions for all interactive nodes (e.g., the recognized real objects and the existing virtual elements) in the MR programming environment.

FIG. 10 shows a process flowchart (1000) for a performance optimization interface executed by the performance optimization module (i.e., 109 in FIG. 1) in the novel real-time object recognition and integration system for mixed-reality programming, wherein the process flowchart (1000) demonstrates how the system dynamically adjusts to maintain optimal performance across different devices and environments, in accordance with an embodiment of the invention.

As illustrated in the process flowchart (1000), in the preferred embodiment of the invention, the performance optimization module maintains system responsiveness and efficiency by taking one or more the following tasks: (1) monitoring the system resource usage and checking the quality of object recognition performance continuously or periodically; (2) if the quality of the object recognition performance is suboptimal, then dynamically adjusting model complexity based on available computational resources; (3) balancing a potential tradeoff between object recognition accuracy and speed to maintain a smooth user experience; and (4) updating system parameters if the model complexity and/or the balance between recognition accuracy and speed are adjusted. Through the dynamic performance optimization executed by the performance optimization module, the novel real-time object recognition and integration system for mixed-reality programming is able to maintain its system efficiency, speed, and effectiveness in providing accurate and real-time object recognition in the visual programming interface utilized by MR content creators.

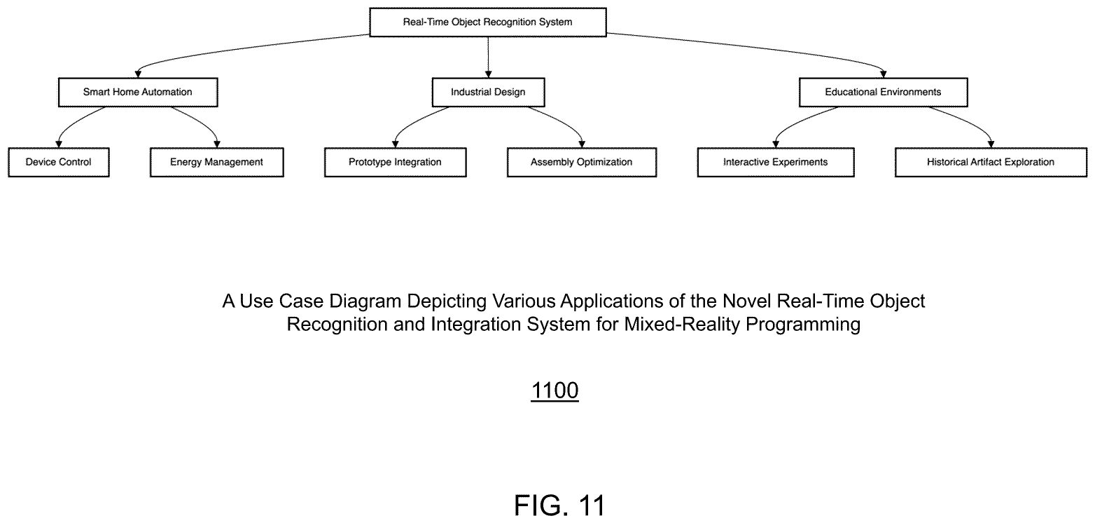

FIG. 11 shows a use case diagram (1100) depicting various applications of the novel real-time object recognition and integration system for mixed-reality programming in diverse domains such as smart homes, industrial design, and educational environments. As illustrated in the use case diagram (1100), the novel real-time object recognition and integration system for mixed-reality programming may be used, for example, in smart home automation for device control and energy management, and also in industrial design for prototype integration and assembly optimization. Furthermore, the novel real-time object recognition and integration system for mixed-reality programming may also be utilized in educational environments, such as interactive experiences and historical artifact explorations.

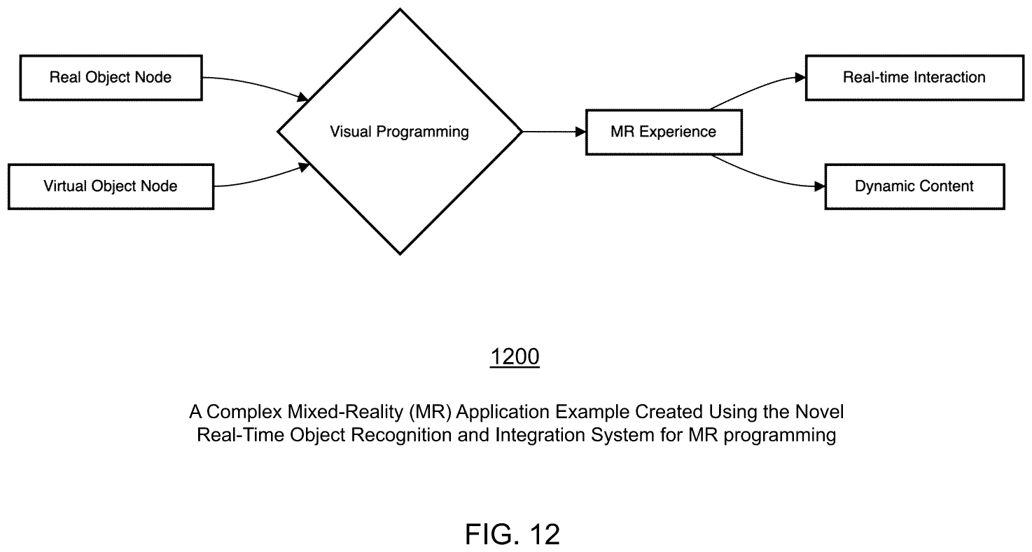

FIG. 12 shows an example (1200) of a complex mixed-reality (MR) application created using the novel real-time object recognition and integration system for mixed-reality programming, wherein the example illustrates both the visual programming representation and the resulting MR experience with integrated real-world objects. In the example (1200) as shown in FIG. 12, real object nodes and virtual object nodes are input parameters to the visual programming interface, from which an MR content creator can compose, edit, or revise a unique MR content (i.e., an MR experience multimedia dataset) that can be visualized either in real time by an MR experience user, or later played back to the MR experience user as an on-demand dynamic content.

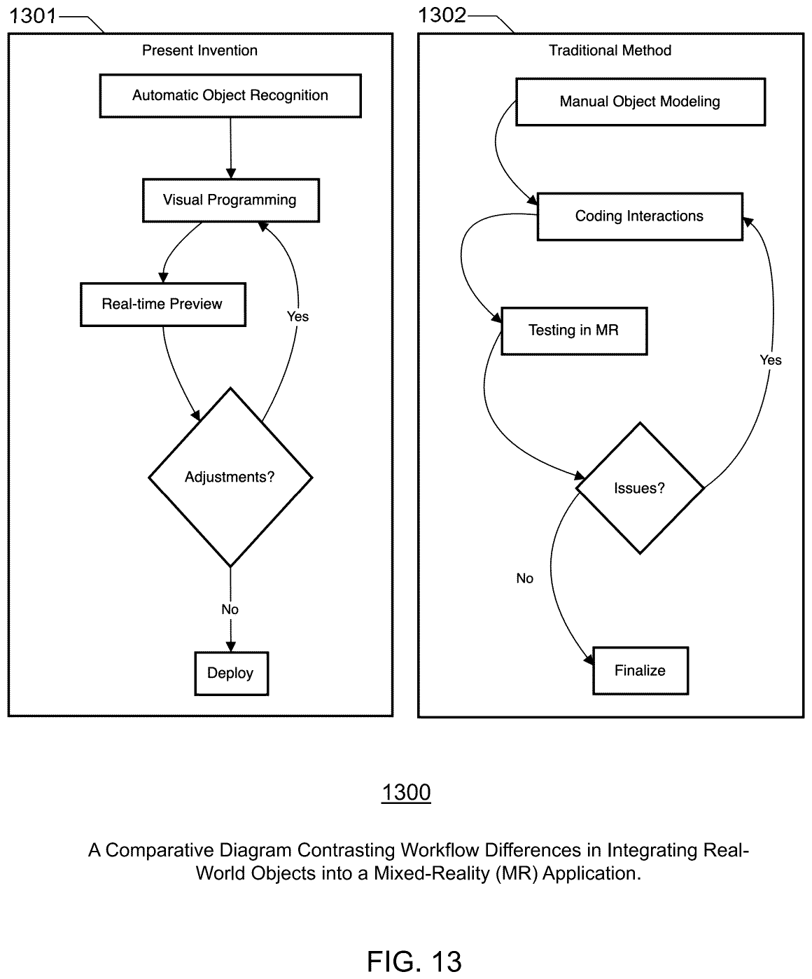

FIG. 13 shows a comparative diagram (1300) contrasting a conventional method (1302) versus an embodiment (1301) of the present invention in workflow differences for integrating real-world objects into a mixed-reality (MR) application. The conventional method (1302) uses a manual object modeling that requires human intervention to capture, transform, and process a physical object in a computerized environment. Then, the computerized physical object model undergoes additional coding for creating interactivity features for the computerized model, which are then tested in a mixed-reality environment until any bugs or problematic issues are resolved.

In contrast, the embodiment (1301) of the present invention utilizes a machine-initiated and automatic object recognition that enables various sensors connected to the multi-modal sensing module and the real-time object detection and recognition engine to scan, detect, and recognize physical objects in real time in a physical space. The automatic object recognition does not require a human operator intervention throughout the object recognition process, and the recognized objects are automatically spatially mapped, anchored, and represented as interactive nodes in a visual programming environment for MR content creators. The interactive nodes can then be further defined or assigned with behavioral traits to incorporate specific interaction possibilities and/or boundaries among the recognized real objects, virtual holographic objects, and prospective MR content users, and be integrated into an MR experience content directed by an MR content creator.

Furthermore, as shown in the embodiment (1301) of the present invention within the comparative diagram (1300), the MR content creator can inspect and revise the newly-created MR experience content via real-time preview in the visual programming interface, and make any desired adjustments before deploying the newly-created MR experience content to the target audience (e.g., electronic devices utilized by prospective MR content users). Compared to the conventional method (1302) for integrating real-world objects into a mixed-reality (MR) application, the embodiment (1301) of the present invention requires less human labor and effort, with more visually-immersive and intuitive editing methods for MR content creators.

FIG. 14 shows the adaptive learning capabilities (1400) of the novel real-time object recognition and integration system for mixed-reality programming, in which the recognition accuracy improves over time for different object classes. As illustrated in FIG. 14, the adaptive learning module (i.e., 106 in FIG. 1) executed by the novel real-time object recognition and integration system provides the adaptive learning capabilities (1400), which involve incorporating the system user (i.e., MR content creator/developer) feedback to update the existing object recognition model. The system user feedback-based refinements and updates to the existing object model, in turn, improve the object recognition accuracy over time, as illustrated in FIG. 14.

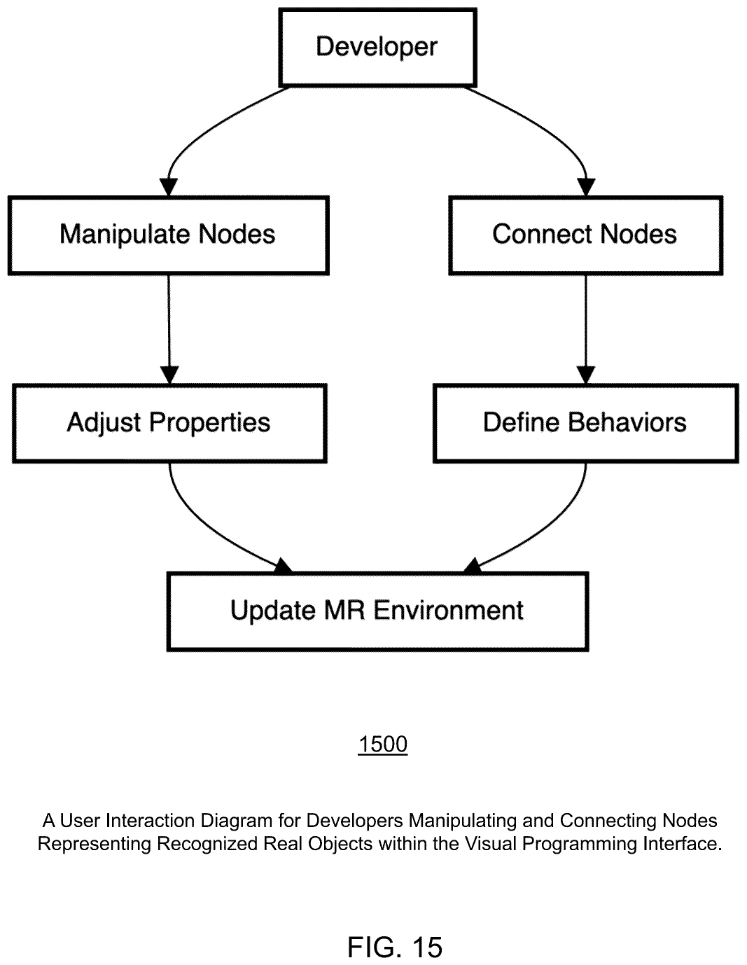

FIG. 15 shows a user interaction diagram (1500) demonstrating how developers can control, manipulate, and connect interactive nodes representing recognized real-world (i.e., physical) objects within the visual programming interface provided by the novel real-time object recognition and integration system for mixed-reality programming. In the preferred embodiment of the invention, an MR content creator can interact with nodes representing real-world objects as well as virtual object nodes in a visually-immersive developer (i.e., visual programming) interface. For example, the MR content creator is empowered to drag and reposition the interactive nodes within the programming canvas, connect nodes to define interactions and data flow, and adjust node properties to modify how a real object is represented or behaves in the MR environment. In the preferred embodiment of the invention, the dynamic node generation module (i.e., 104 in FIG. 1) and the spatial mapping and anchoring system (i.e., 103 in FIG. 1) executed by the novel real-time object recognition and integration system are able to provide interactive node modification and update capabilities to the MR content creator.

In addition, the novel real-time object recognition and integration system for mixed-reality programming also includes the safety and validation layer (i.e., 110 in FIG. 1), which implements and enforces safety provisions and rules to prevent and/or deter accidents, injuries, or other harmful consequences to a user interacting with real (i.e., physical) objects in an MR environment created by a content creator through the visual programming interface. The safety and validation layer (i.e., 110 in FIG. 1) empowers the content creator to generate or synthesize a user safety protocol that defines interactive limits and boundaries in the MR interactions between the prospective users and the real objects in the MR environment to prevent user injuries or other harmful interactions, when the prospective users are immersed in the MR environment.

The safety and validation layer (i.e., 110 in FIG. 1) in the novel real-time object recognition and integration system for mixed-reality programming implements checks and balances to prevent potentially-harmful and/or dangerous interactions between real physical objects and users immersed in a mixed-reality (MR) environment. The safety and validation layer is configured to detect or predict potential interaction between a physical object and an MR user, and then determines whether this potential interaction is safe to the MR user. If the potential interaction is determined or predicted to be safe by safety and validation layer, then the novel real-time object recognition and integration system allows the potential interaction between the physical object and the MR user. In contrast, if the potential interaction is determined or predicted to be unsafe by the safety and validation layer, then the novel real-time object recognition and integration system blocks the potential interaction and displays safety warning to the content creator at the MR environment development stage, or to the MR user during his or her immersive participation in the MR content.

It is important to note that without the uniquely-novel safety and validation layer built into the novel real-time object recognition and integration system, a user immersed in the MR environment may accidentally collide with a physical object, or get harmed by the dangerous nature (e.g., an industrial machinery, a heavy or sharp object, a sensitive animal, etc.) of the physical object, if the MR content creator does not proactively incorporate safety provisions when designing the boundaries of possible interactions between the user and the physical object present in the MR environment. Therefore, the safety and validation layer improves user safety in potentially-injurious or harmful situations involving various physical objects present in the MR environment by preemptively provisioning safety boundaries at the MR experience design stages by content creators.

Various embodiments of the present invention for novel real-time object recognition and integration for mixed-reality (MR) programming and related methods of operating the invention described herein provide significant advantages over conventional mixed-reality object recognition tools. For example, an embodiment of the present invention provides a more advanced and integrated approach to real-time object recognition and integration in mixed-reality (MR) programming environments.

Moreover, the novel real-time object recognition and integration system for mixed-reality (MR) programming, implemented in accordance with an embodiment of the present invention, provides a robust and adaptable object recognition system that seamlessly bridges the gap between physical objects and digital representations to enable rich and context-aware interactions in a visual programming interface and a corresponding framework for MR applications.

In addition, the novel real-time object recognition and integration system for mixed-reality (MR) programming, implemented in accordance with an embodiment of the present invention, accommodate visually-intuitive integration between virtual and real elements for incorporating seamless interactions between the virtual and real elements during an MR content synthesis, instead of treating such elements separately, as in the case with existing legacy AR/VR/MR programming tools.

Furthermore, the novel real-time object recognition and integration system for mixed-reality (MR) programming, implemented in accordance with an embodiment of the present invention, empowers a mixed-reality (MR) content creator to integrate robust and proactive user safety protocols, at the interaction design stage of an MR content, to prevent accidents or potentially-harmful interactions between a user immersed in the MR content and a physical object incorporated in the MR content.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the claims.

What is claimed is:

1. A real-time object recognition and integration system for mixed-reality (MR) programming comprising:
a diverse set of sensors including at least one of a camera, a depth sensor, and an inertial measurement unit (IMU) sensor, wherein the diverse set of sensors is integrated into a head-mounted display device or another portable electronic
device, and wherein the head-mounted display device or the another portable electronic device is configured to transmit sensory data captured from the diverse set of sensors, which are located in a physical space intended to be utilized as a mixed-reality (MR) environment, to a multi-modal sensing module;
the multi-modal sensing module configured to receive the sensory data captured from the diverse set of sensors, wherein the multi-modal sensing module then fuses the sensory data via a data fusion block to generate fused sensory data;
a real-time object detection and recognition engine utilizing a neural network to identify, classify, and track a real physical object from the fused sensory data;
a spatial mapping and anchoring system configured to map the physical space to generate the mixed-reality (MR) environment and to locate and correlate the real physical object and other identified real and virtual objects in the MR environment;
a dynamic node generation module configured to generate interactive nodes for the real physical object and the other identified real and virtual objects in a visual programming interface connected to the MR environment;
a visual programming interface connector configured to connect the dynamic node generation module to the visual programming interface provided by a visual programming system;
a safety and validation layer configured to empower a mixed-reality (MR) content creator to synthesize a user safety protocol that defines interactive limits and boundaries in mixed-reality (MR) interactions between prospective users and the real physical object to prevent user injuries or other harmful interactions when the prospective users are immersed in the MR environment; and
a memory unit and at least one of a central processing unit (CPU), an application processing unit (APU), and a graphical processing unit (GPU) of a computer server or another computing device executing the multi-modal sensing module, the real-time object detection and recognition engine, the spatial mapping and anchoring system, the dynamic node generation module, and the safety and validation layer, wherein the computer server or the another computing device is also operatively connected to the head-mounted display device or the another portable electronic device integrating the diverse set of sensors for data communication.

2. The real-time object recognition and integration system of claim 1, further comprising a context analysis engine, which interprets spatial and temporal relationships between the real physical object and the other identified real and virtual objects in the MR environment.

3. The real-time object recognition and integration system of claim 1, further comprising an adaptive learning module, which continuously refines an object recognition model by collecting a feedback from the MR content creator, incorporating new instances of object recognition, updating training data, and retraining the object recognition model, wherein the object recognition model is executed by the real-time object detection and recognition engine.

4. The real-time object recognition and integration system of claim 1, further comprising an interaction modeling system, which assigns or defines behaviors and specific actions of the interactive nodes based on directions given by the MR content creator in the visual programming interface, wherein the interactive nodes represent the real physical object and the other identified real and virtual objects in the visual programming interface.

5. The real-time object recognition and integration system of claim 1, further comprising a performance optimization module, which maintains efficiency, speed, and accuracy of the real-time object recognition and integrating system by continuously or periodically checking object recognition performance, adjusting model complexity, and balancing a tradeoff between the speed and the accuracy.

6. The real-time object recognition and integration system of claim 1, wherein the visual programming interface is rendered in three dimensions within the MR environment.

7. The real-time object recognition and integration system of claim 1, wherein the user safety protocol, which defines the interactive limits and the boundaries in the MR interactions between the prospective users and the real physical object, includes blocking a potential interaction with the real physical object or displaying a safety warning to the prospective users while being immersed in the MR environment.
